(19) United States
(12) Patent Application Publication
(10) Pub. No.: US 2024/0389618 A1
(43) Pub. Date: Nov. 28, 2024

(54) METHODS FOR DELIVERING 24-METHYLENE CHOLESTEROL, ISOFUCOSTEROL, CHOLESTEROL OR DESMOSTEROL TO INVERTEBRATES, IN PARTICULAR HONEY BEES OR BUMBLE BEES

(71) Applicant: Apix Biosciences, Wingene (BE)

(72) Inventors: Thierry BOGAERT, Wingene (BE); Sharoni SHAFIR, Wingene (BE); Geraldine WRIGHT, Oxford (GB)

(21) Appl. No.: 18/694,132

(22) PCT Filed: Sep. 27, 2022
(86) PCT No.: PCT/EP2022/076785

§ 371 Date: Mar. 21, 2024

(30) Foreign Application Priority Data
Sep. 28, 2021 (BE) BE2021/5756
Oct. 4, 2021 (WO) PCT/EP2021/077325

(51) Int. Cl. A23K 10/16; A23K 50/90

(52) U.S. Cl. CPC A23K 10/16; A23K 50/90

(57) ABSTRACT

A method for feeding invertebrates comprising: ▪providing a composition comprising a microbial organism or parts, extracts, oils or refinements thereof; and ▪administering the composition to invertebrates wherein the microbial organism is selected from the group consisting of Saccharomyces cerevisiae, Xanthophyllomyces sp., S. japonicus or Yarrowia Hpolytica; and wherein the microbial organism has been genetically modified to produce an invertebrate nutrient selected from the group consisting of 24-methylene cholesterol, isofucosterol, cholesterol or desmosterol.

### BACKGROUND

Bees are very important in modern agriculture for the pollination of crops. Pollinators have recently been under threat due to exposure to pesticides, increased prevalence of pathogens and parasites, and changes to landscape management that reduce the abundance of naturally occurring floral pollen.

Beekeepers have historically fed honeybee colonies with a food source that contains pollen or pollen collected in nature by bees. Because pollen collection is limited in availability and scale, pollen collection is costly, pollen is hard to keep fresh and pollen collected in the wild can carry pests, diseases, and pesticides. Therefore, commercially available feeds usually do not contain pollen.

These pollen substitute compositions have already been described by the present inventors. US2019/0090507 to Apix Biosciences stresses the importance of plant sterols and, in particular, of 24-methylene cholesterol, campesterol, β-sitosterol, and cholesterol. However, US2019/0090507 does not disclose 24-methylene cholesterol, campesterol, β-sitosterol, and cholesterol obtained from genetically modified microorganism. US2019/0090507 to Apix Biosciences also identifies the importance of phenolic compounds, carotenoids, and vitamins C and E as nutrients for bees, but does not disclose that these could be obtained from a microorganism.

Yeasts are used to feed invertebrates, in particular honey bees or bumble bees. However, yeasts produce ergosterol. Ergosterol is an antinutrient for invertebrates, such as honey bees or bumble bees.

Moreover, culturing yeasts requires the addition of sterols to the yeast culture. In this respect, WO 2021/133171 to the University of Delft discloses recombinant yeast cells expressing a protein having squalene-tetrahymanol cyclase activity and a protein having squalene-hopene cyclase activity. The recombinant yeast cells require less or no addition of sterols to the culture medium. Squalene (or hopene in case of squalene-hopene cyclase in Schizosaccharomyces japonicus, hereinafter referred as S. japonicus) can complement the absence or dysfunction in the functions that sterols typically perform in the yeast cells.

### SHORT DESCRIPTION OF THE INVENTION

The present inventors have surprisingly established that essential nutrients, in particular sterols, stanols, polyphenols, and carotenoids, that may be effectively administered to invertebrates, in particular bees through synthesis or production in microorganisms or parts thereof. Examples of such sterol nutrients are cholesterol, desmosterol, 24-methylene cholesterol, 7-dehydroxycholesterol, campesterol, stigmasterol, b-sitosterol, isofucosterol and fucosterol. Examples include the stanols such as cholestanol and 24-methylenecholst-7-enol. Examples of polyphenols include the flavenols, quercetin and rutin, and phenolic acids such as p-coumaric acid. Examples of carotenoids include b-carotene and astaxanthin.

Accordingly, a first aspect of the invention is a method for feeding invertebrates comprising:
providing a composition comprising a microbial organism or algal species or parts, extracts, oils or mixtures or refinements thereof;
administering this composition to a target species
   wherein the organism is selected from the group consisting of fungi, algae or bacteria; and wherein the microbial organism is producing a nutrient naturally or after selection or modification of the microbe.

Another aspect is a method for feeding invertebrates comprising:
providing a composition comprising a yeast or parts, extracts, oils, mixtures or refinements thereof; and
administering the composition to invertebrates,
   wherein the yeast is selected from the group consisting of Saccharomyces cerevisiae, Xanthophyllomyces sp., S. japonicus or Yarrowia lipolytica;
   wherein the yeast has been (genetically) modified, enhanced or selected to produce an invertebrate nutrient selected from the group consisting of cholesterol, desmosterol, 24-methylene cholesterol, and isofucosterol.

In another aspect, the yeast has been modified or enhanced as compared to a parent yeast to express a squalene-hopene cyclase enzyme or a squalene-tetrahymenol cyclase enzyme to enable growth under anoxic conditions.

In another aspect, the invertebrate nutrient is produced under aerobic conditions.

In another aspect, the nutrient is selected from the group consisting of sterols or stanols including but not limited to: cholesterol, desmosterol, 24-methylene cholesterol, cholestanol, campesterol, stigmasterol, b-sitosterol, isofucosterol and fucosterol.

In another aspect, the nutrient is selected from the group consisting of phenolic acids, epicatechins, catechins, and flavonoids.

In another aspect, the nutrient is selected from the group consisting of carotenes and xanthophylls including b-carotene, astaxanthin, zeaxanthin.

In another aspect, the microorganism has been further modified or selected not to express or produce antinutrients.

In another aspect, the invertebrate antinutrient is zymosterol or ergosterol.

In another aspect, the composition is a whole target species diet, part of a target species diet or a dietary supplement, or topical application.

In another aspect, the composition is a composition for a cell culture or organoid culture diet, part of a diet or a dietary supplement for cellular culture or organoid.

In another aspect, the composition is an invertebrate species diet, part of a target species diet or a dietary supplement, or topical application.

In another aspect, the composition is administered to invertebrates of the Apidae family, in particular honey bees, bumble bees or stingless bees.

In another aspect, the composition is administered
in solid form such as a patty or in liquid form such as a solution or spray, granule or powder;
inside or outside the hive.

In another aspect, the organism is selected from the group consisting of:
a marine or freshwater algal species, in particular an extract, an oil or a refinement of Ulva lactuca or Laminaria sp.;
a marine diatom or microalgal species, in particular an extract, an oil or a refinement of diatoms such as Thalassiosira pseudonana, Thalassiosira rotula, or Chaetoceros muelleri or microalgae such as Dunaliella salina or Porphyridium cruentum; and
a fungus, in particular an extract, an oil or a refinement of yeast species such as Saccharomyces cerevisiae, Xanthophyllomyces dendrorhus or Yarrowia lipolytica, Aspergillus, Botrytis, Cercospora, Fusarium (Gibberella), Kluyveromyces, Neurospora, Penicillium, Pichia {Hansenula), Puccinia, Saccharomyces, Schizosaccharomyces, Sclerotium, Trichoderma, and Xanthophyllomyces (Phqffia); in some embodiments, the organism is of a species including, but not limited to, Aspergillus nidulans, A. niger, A. terreus, Botrytis cinerea, C. utilis, Cercospora nicotianae, Fusariumfujikuroi (Gibberella zeae), Kluyveromyces lactis, K. lactis, Neurospora crassa, Pichia pastor is, Puccinia distincta, Saccharomyces cerevisiae, Schizosaccharomyces pombe, Sclerotium rolfsii, Trichoderma reesei, and Xanthophyllomyces dendrorhous {Phaffia rhodozymd), preferably Yarrowia lipolytica

In another aspect, there is a chemical, chromatographic or enzymatical modification step to obtain the invertebrate nutrient.

In another aspect, the composition for a member of the Apidae family comprises:
proteins in an amount from 10 w % to 50 w %, preferably of 20 w % to 40 w %,
fatty acids in an amount from 1 w % to 20 w %, preferably of 2 w % to 12 w %,
carbohydrates in an amount from 30 w % to 90 w %, preferably of 50 w % to 70 w %,
optionally vitamins, and
optionally minerals,
   wherein the total amount of components add up to 100 w % and wherein the w % are related to the total dry weight of the composition.

In another aspect, the composition comprises cholesterol, desmosterol, 24-methylene cholesterol, and isofucosterol in an amount from 0.01-5% of the diet, preferably from 0.01-1% and even more preferably from 0.03-0.5% for honey bees and 0.03-0.8% for bumble bees as a percentage of the total (dry) weight of the pollen substitute composition.

In another aspect, the composition comprises of an insect nutrient selected from the group consisting of cholesterol, desmosterol, cholestanol, 24-methylene cholesterol, 24-methylenecholst-7-enol, campesterol, stigmasterol, b-sitosterol, isofucosterol and fucosterol or mixtures thereof in an amount from 0.01-5% of the diet as individual compounds, where no compound is ever less than 0.01% of the diet and from 0.1-5% of the diet in a mixture.

As a mixture, preferably from 0.1-1% and even more preferably from 0.3-0.5% for honey bees and 0.3-0.8% for bumble bees as a percentage of the total wet weight of the pollen substitute composition and/or

Where the ratios of the sterols represent the quantities found in the target species, such as bees (see Table 1).

In another aspect, the composition comprises an insect nutrient selected from the group consisting of phenolic acids, proanthocyanidins, epicatechins, catechins, and flavonoids such as quercetin, naringenin, p-coumaric acid or mixtures thereof in an amount from 0.01-5% of the diet, preferably from 0.01-1% and even more preferably from 0.03-0.5% for honey bees and 0.03-0.8% for bumble bees as a percentage of the total weight of the pollen substitute composition and where the predominant class of phenolics is either proanthocyanidins or flavonoids and makes up at least 30% of the total polyphenols, but preferably between 70-100% of the total polyphenols.

In another aspect, the composition comprises a nutrient for a target species selected from the group consisting of carotenoids or xanthophylls such as b-carotene, lycopene, or astaxanthin or mixtures thereof in an amount from 0.01-5% of the diet, preferably from 0.01-1% and even more preferably from 0.03-0.5% for honey bees and 0.03-0.8% for bumble bees as a percentage of the total weight of the pollen substitute composition.

In another aspect, the composition for the target species is essentially free of pollen.

A further aspect of the invention is the use of a composition comprising a microbial organism or parts, extracts, oils, mixtures, or refinements thereof,
wherein the microbial organism is selected from the group consisting of fungi, algae or bacteria; and
wherein the microbial organism has been modified or selected to produce a target species nutrient;
   for feeding invertebrates.

In another aspect of the use, the composition comprises:
proteins in an amount from 10 w % to 50 w %, preferably of 20 w % to 40 w %,
fatty acids in an amount from 1 w % to 20 w %, preferably of 2 w % to 12 w %,
carbohydrates in an amount from 30 w % to 90 w %, preferably of 50 w % to 70 w %,
optionally vitamins, and
optionally minerals,
   wherein the total amount of components add up to 100 w % and wherein the w % are related to the total wet weight of the composition for feeding invertebrates, in particular bees or bumble bees.

In another aspect of the use of the present invention, the composition is essentially free of pollen.

Another aspect of the invention is a composition comprising:
proteins in an amount from 10 w % to 50 w %, preferably of 20 w % to 40 w %,
fatty acids in an amount from 1 w % to 20 w %, preferably of 2 w % to 12 w %,
carbohydrates in an amount from 30 w % to 90 w %, preferably of 50 w % to 70 w %,
optionally vitamins, and
optionally minerals,
   wherein the total amount of components add up to 100 w % and wherein the w % are related to the total dry weight of the composition and wherein the composition is essentially free of antinutrients.

### SHORT DESCRIPTION OF THE DRAWINGS

FIG. 1 shows the choice of cohorts of bees of diet with or without isofucosterol.

FIG. 2 shows the survival of cohorts of bees confined to feed on diets containing specific concentrations of isofucosterol.

FIG. 3 shows the threshold for the influence of isofucosterol in bee diet for brood.

FIG. 4 shows the impact of sterols on brood production: Honey bees produce more brood with a plurality of sterols and produce brood for longer periods of time.

FIG. 5 shows the impact of sterols on brood production: Honey bees were more efficient at producing brood per unit protein when sterols were added to diet.

FIG. 6 shows the impact of sterols on brood production: Honey bees produced brood for longer period with a plurality of required sterols than with any other sterol provision.

FIG. 7 shows the impact of sterols on survival: Honey bees live longer on foods containing astaxanthin.

### DETAILED DESCRIPTION OF THE INVENTION

The inventors have surprisingly found that yeast cells or extracts of Saccharomyces cerevisiae, Xanthophyllomyces sp., S. japonicus or Yarrowia lipolytica may be administered to the invertebrates, in particular the honey bees and the bumble bees, to deliver nutrients. Preferably, the yeast cells have been enhanced or modified to express or produce an invertebrate nutrient selected from the group consisting of cholesterol, desmosterol, 24-methylene cholesterol, and isofucosterol. In a preferred embodiment, the enhanced or modified yeast is ergosterol-free. That means that the yeast is not expressing antinutrients such as ergosterol in nutritionally effective amount. In another preferred embodiment, the yeast has been modified to further express a squalene-hopene cyclase enzyme or a squalene-tetrahymenol cyclase enzyme to enable growth under anoxic conditions.

Embodiments of the present inventions are described hereinafter.

### Yeasts

Preferred microorganisms are yeasts, preferably selected from the group consisting of Saccharomycesceae, such as Saccharomyces cerevisiae, Saccharomyces pastorianus, Saccharomyces beticus, Saccharomyces fermentati, Saccharomyces paradoxus, Saccharomyces uvarum and Saccharomyces bayanus; Torulaspora, such as Torulaspora delbrueckii; Kluyveromyces, such as Kluyveromyces marxianus and Kluyveromyces lactis; Pichia, such as Pichia stipitis (also known as Scheffersomyces stipitis), Pichia pastoris; Ogataea, such as Ogataea parapolymorpha; Zygosaccharomyces, such as Zygosaccharomyces bailii; Brettanomyces, such as Brettanomyces intermedius, Brettanomyces bruxellensis, Brettanomyces anomalus, Brettanomyces custersianus, Brettanomyces naardenensis, Brettanomyces nanus, Dekkera bruxellis and Dekkera anomala; Metschnikowia; Issatchenkia, such as Issatchenkia orientalis; and Kloeckera, such as Kloeckera apiculata. In further embodiments, the parental fungal cell may be selected from the group comprising Schizosaccharomycesceae, such as Schizosaccharomyces, for example Schizosaccharomyces pombe, Schizosaccharomyces japonicus, Schizosaccharomyces octosporus and Schizosaccharomyces cryophilus, especially selected from the group comprising Schizosaccharomyces pombe, Schizosaccharomyces octosporus and Schizosaccharomyces cryophilus; or from the group of Dothideomycetes, such as Aureobasidium pullulans; or from the group of Dipodascaceae, such as Yarrowia lipolytica.

Particularly preferred are Saccharomyces cerevisiae, Xanthophyllomyces sp., S. japonicus or Yarrowia lipolytica.

### Modification or Enhancement of Microorganisms, in Particular Yeasts

Modification means any genome modification as compared to the parent microorganism, for example heterologous gene expression.

The term genome modification refers to a difference between two genomes, especially wherein the difference was deliberately introduced. In one embodiment, the genome modification may comprise one or more of an insertion, a deletion and a substitution of nucleotides. In a preferred embodiment, the genome modification comprises the insertion of an exogenous gene. Modifications include recombinant gene technology, mutations or gene editing.

In one embodiment, the modified yeast cell may be configured to express the exogenous gene. In particular, the modified yeast cell may be configured to transcribe an exogenous gene into mRNA. In particular, the modified yeast cell is configured to translate an exogenous mRNA into an exogenous protein.

In one embodiment, one or more exogenous genes encode a protein having squalenetetrahymanol cyclase activity and/or a protein having squalene-hopene cyclase activity. The activity may determined by comparing the expression pattern of the modified cell as compared to a cell devoid of such a modification.

Enhancement means any improvement of the expression of an invertebrate nutrient as compared to the parent microorganism which has not been enhanced or modified for the expression of this invertebrate nutrient.

In one embodiment, the yeasts have been modified or selected to produce an invertebrate nutrient selected from the group consisting of cholesterol, desmosterol, 24-methylene cholesterol, and isofucosterol.

In one embodiment, the yeast has been modified or enhanced as compared to a parent yeast to express a squalene-hopene cyclase enzyme or a squalene-tetrahymenol cyclase enzyme to enable growth under anoxic conditions and/or complement the sterol function in yeast cells under anoxic conditions or conditions when other sterols than the endogenous sterols are expressed after modification of the yeast cell.

### Enhanced or Modified Yeast Cells

In one embodiment, cells of Saccharomyces cerevisiae, Xanthophyllomyces sp., S. japonicus or Yarrowia lipolytica are administered to the invertebrates, in particular the honey bees and the bumble bees, wherein the yeast cells have been enhanced or modified to express or produce an invertebrate nutrient selected from the group consisting of cholesterol, desmosterol, 24-methylene cholesterol, and isofucosterol.

### Squalene-Hopene Cyclase or a Squalene-Tetrahymenol Cyclase

In one embodiment, the yeast has been modified to express a squalene-hopene cyclase enzyme or a squalene-tetrahymenol cyclase enzyme in order to allow it to grow in anoxic conditions. Preferably, no sterols or a reduced amount of sterols are added to the culture medium of the modified yeast as compared to a parent yeast cell that lacks this modification. WO 2021/133171 to the University of Delft provides examples of such modified yeast cells. A preferred example is example 4 of WO 2021/133171 to the University of Delft.

S. japonicus was shown to naturally express hopenes that fulfil the role of sterols when the yeast is grown anoxically. Such S. japonicus wt strain is one embodiment of a background strain into which the sterol pathway can be engineered to produce the nutritionally desired sterols 24 methylene cholesterol, desmosterol, cholesterol or isofucsterol and not ergosterol. In such S japonicus strain the hopene will complement cellular dysfunction due to expression of a non natural sterol. The same situation can be engineered in a non S. japonicus yeast by expression the squalene-tetrahymenal or squalene-hopene cyclase together with the expression of the desired sterol.

### Anoxic or Aerobic Culturing Conditions

In one embodiment, the modified or enhanced microorganisms is S. japonicus cultured under anoxic conditions. In such conditions, typically no sterols are formed due to the lack of oxygen and hopene takes over the sterol function. In this embodiment, the modified or enhanced microorganisms are engineered to produce non-ergosterols such as 24-methylene cholesterol, isofucosterol, cholesterol or desmosterol under aerobic conditions.

In another embodiment, the modified or enhanced microorganisms are species of yeast in which a squalene-hopene cyclase enzyme is expressed and/or squalene-tetrahymenol cyclase enzyme is expressed enabling growth under anoxic conditions and tetrahymenol takes over the sterol role. No sterols can be formed due to lack of oxygen. Engineered non-ergosterols, such as 24-methylene cholesterol, isofucosterol, cholesterol or desmosterol are formed under aerobic conditions.

In another embodiment, the modified or enhanced microorganisms are a species of yeast such as S. cerevisiae or Yarrowia in which a squalene-hopene cyclase enzyme is expressed and/squalene-tetrahymenol cyclase enzyme is expressed enabling yeast growth under anoxic conditions. In anoxic conditions, normally no sterols can be formed due to lack of oxygen. In this embodiment, the microorganisms have been enhanced or modified to produce non-ergosterols, such as 24-methylene cholesterol, isofucosterol, cholesterol or desmosterol under aerobic conditions, preferably without expressing ergosterol.

### Aerobic Culturing Condition

In another embodiment, the modified or enhanced microorganisms are a species of yeast such as S. cerevisiae or Yarrowia, which are cultured under aerobic conditions to express or produce non-ergosterols, such as 24-methylene cholesterol, isofucosterol, cholesterol or desmosterol, preferably without producing or expressing ergosterol.

### Sterol Nutrients and Sterol Antinutrients for Invertebrates

Microorganisms, plants and higher animal lineages synthesize sterol compounds de novo. The invertebrate protostome group of animals, however, are sterol auxotrophs and must obtain sterols from diet. For example, some insect herbivores such as locusts consume plants or fungi and convert naturally occurring phytosterols like b-sitosterol into cholesterol. Insect predators, scavengers, and parasites obtain cholesterol directly from the foods they consume. Still other invertebrates such as honey bees (Apis melifera) obtain other sterols directly from pollen and incorporate some of them unmodified into their tissues (Svoboda et al. 1981). Uptake of sterols and the profile of sterols in invertebrate tissue depends on the composition of the substrate, the animal's ability to use and/or modify specific sterols present in food, and other environmental variables such as temperature (Knittlefelder et al 2020). Lipids are very important in all organisms and are the substrates for the production of signalling molecules. They are also used as storage molecules for energy in animals. Specific forms of lipids, such as sterols, are essential elements of cell membranes. Sterols are also as the substrates for the creation of hormones, pheromones, defensive compounds or substrates for vitamin synthesis:

Many insects take up sterols from their food and use them, unmodified, in the membranes of their tissues (e.g. Drosophila), Honey bees are an example of an invertebrate animal that takes up sterols from its food source and sequesters them in tissues unchanged. It is also an animal that requires several sterol compounds. Research carried out in the 1980's by the USDA labs in Beltsville studied the sterol composition of honey bees and the post-ingestive modification of selected sterol compounds in the Hymenoptera. They identified that at least seven sterols found in bee tissues: cholesterol, campesterol, 24-methylene cholesterol, desmosterol, stigmasterol, b-sitosterol, and isofucosterol (see Table 1).

Svoboda established through radiolabelling studies that 24-methylene cholesterol, sitosterol and campesterol are acquired from diet (pollen) and not converted into cholesterol (Svoboda et al. 1981). These data led them to conclude that honey bees lack functional genes for the enzymes necessary to convert 24-methylene cholesterol, sitosterol or campesterol to cholesterol.

For this reason, the phytosterols, 24-methylene cholesterol, sitosterol, cholesterol and campesterol, are considered to be essential nutrients of bee diet that are acquired from pollen. The roles, source of and requirements for desmosterol, b-sitosterol, stigmasterol, and isofucosterol in bee tissues are unknown. They are present in honeybee tissues at nearly 50% of the bee's sterols (combined, Table 1). In honey bees as in other insects, cholesterol is converted into ecdysteroids (e.g. 20-hydroxyecdysone). These compounds are the major hormones orchestrating moulting and reproduction changes in insects (Svoboda and Feldlaufer, 1991). Campesterol is the substrate necessary to create the moulting hormone makisterone A (Feldlaufer et al. 1986). The sterol, 24-methylene cholesterol, makes up 40-50% of the sterols in honeybee tissues and is an important constituent of the membranes of bee cells. Its absence leads to, hypopharyngeal glands atrophy (Chakrabarti et al. 2020) and bees cease to produce brood (Herbert et al. 1980). In bumble bees, desmosterol, b-sitosterol, stigmasterol, and isofucosterol sterols make up 70-80% of the sterols in tissue (Table 1). Given that the bee's natural food can contain up to 30 different sterols (Vilette et al. 2015; Zu et al. 2021), it is likely that these remaining sterols are incorporated into bee tissue in place of cholesterol in the same way that 24-methylene cholesterol is. The data in Table 1 indicate the quantities of these seven sterols for eusocial bees.

The phytosterols listed in Table 1 are found in low to trace amounts in the plant flour used or available to the bee food manufacturer. The single flour sources used by commercial bee food producers today do not contain all of the necessary sterols, as shown in comparative Table 1.

Moreover, a single plant species pollen does not provide all seven sterols needed by honey bees (Vilette et al. 2015). In nature, foraging bees collect pollen from diverse plant sources, each of which may contain some but not all of the other important sterols. No single plant species' pollen contains all bee relevant sterols in the right quantity and ratios (Vilette et al. 2015). Mixed pollen is used to supplement commercial bee feeds, but it is expensive and can harbor pesticides and bee pathogens. Using bee-collected pollen obtained in one location to feed bees in another, pollen limited area is not feasible for the numbers of colonies reared for commercial pollination today (i.e. hundreds per apiary site).

TABLE 1
Sterol composition (% total of relevant sterols) of honey bees and bumble bees

| | | | | | | | | | | Total |
|---|---|---|---|---|---|---|---|---|---|---|
| | CHO | DES | 24MC | CMP | STIG | B-SIT | ISF | ZYM | ERG | (μg/g) |
| Honey bees | | | | | | | | | | |
| Bee- | 1.15 | 15.0 | 21.19 | 3.25 | 0.53 | 25.92 | 32.95 | 0.00 | 0.00 | 2418 |
| collected | | | | | | | | | | |
| Pollen | | | | | | | | | | |
| Bee bread | 1.20 | 28.4 | 23.10 | 2.95 | 0.43 | 14.67 | 29.22 | 0.00 | 0.00 | 1973 |
| Royal jelly | 0.88 | 9.43 | 40.22 | 6.70 | 0.71 | 21.73 | 20.34 | 0.00 | 0.00 | 729.9 |
| Queen | 0.37 | 1.45 | 54.39 | 3.34 | 0.33 | 20.04 | 20.08 | 0.00 | 0.00 | 1454 |
| Drone | 1.28 | 0.41 | 43.21 | 6.28 | 1.64 | 19.87 | 27.30 | 0.00 | 0.00 | 1962 |
| Worker | 1.23 | 2.48 | 42.05 | 5.09 | 0.53 | 20.95 | 27.67 | 0.00 | 0.00 | 1738 |

Bumble bees

| | | | | | | | | | | |
|---|---|---|---|---|---|---|---|---|---|---|
| Larva | 0.58 | 0.77 | 17.15 | 3.97 | 0.61 | 21.16 | 55.76 | 0.00 | 0.00 | 1674 |
| Queen | 1.36 | 0.15 | 23.39 | 8.29 | 1.67 | 14.06 | 51.08 | 0.00 | 0.00 | 429.8 |
| Drone | 0.29 | 0.27 | 28.05 | 6.07 | 0.60 | 23.64 | 41.07 | 0.00 | 0.00 | 1469 |
| Worker | 0.54 | 0.20 | 17.82 | 6.09 | 0.86 | 24.71 | 49.78 | 0.00 | 0.00 | 2116 |

Svoboda et al. 1980

| | | | | | | | | | | |
|---|---|---|---|---|---|---|---|---|---|---|
| Worker | 1.2 | 1.1 | 46.6 | 8.8 | 3.9 | 23 | 15.4 | 0.00 | 0.00 | N/A |

* from Svoboda et al 1980 JInsPhys 26: 291-294
** methods for analysis from Zu et al. 2021 New Phyt 230: 1169-1184
CHO = cholesterol,
DES = desmosterol,
24MC = 24-methylene cholesterol,
CMP = campesterol,
STIGM = stigmasterol,
b-SIT = b-sitosterol,
ISF = isofucosterol,
ZYM = zymosterol,
ERG = ergosterol

### Administration of Sterol Nutrients Through Microorganisms

Commercial production of animals requires the development of cost-effective yet nutritionally optimal feeds. Commercial pollen substitutes for honey bees are produced from seed flours and Brewer's yeast and do not contain all of the required sterols that bees need to produce brood and those it contains are not in the optimal ratios (Comparative Table 1. Herbert et al. 1980).

Two of the most important and abundant sterols missing in current bee foods (Comparative Table 1) are 24-methylene cholesterol and isofucosterol. Other steroids such as desmosterol and stigmasterol are present in smaller amounts but may be equally relevant.

Furthermore, commercial foods also contain significant quantities of ergosterol: a sterol that is not present in bee tissues and is harmful as we discovered that it is a substance that bees avoid consuming when they have a choice. Harm is caused by avoidance of eating a food and by supplying pathogens with nutrition or causing direct harm through metabolic pathways.

A strain of a panel of strains delivering rare sterols to an invertebrate food has broader applications as a source for sterols for invertebrates:
cholesterol for arthropods.
24-methylene cholesterol for marine invertebrates such as molluscs grown in aquaculture (clams, oysters, squid)
Other insects—bumble bees, red mason bees, stingless bees, locusts, crickets, mealworms, and black soldier flies

The principle for making such yeast strains is well known to those experienced in the art:
An ergosterol deficient strain of S. cerevisiae can for example be made by deleting the genes erg4 and erg 5 in S. cerevisiae (eg. BG4742 erg4 erg5 Japanese paper). The same can be done in Yarrowia lipolytica by deleting the orthologues of erg4 and erg 5. Such ergosterol deficient strain can be made to express 24-methylene cholesterol as it primary sterol by expressing the St DWF5 cDNA or any enzyme with the same activity in this strain (Strain T21). Expression of the SSR2 gene in this 24-methylene cholesterol accumulating strain resulted in the production of cholesterol.
A S. cerevisiae yeast strain making desmosterol as its major sterol strain can be made by deleting the yeast gene erg6 (or its orthologue in Y. lipolytica or in other yeast species) and expressing St DWF5 or any enzyme with the same activity (strain T31). Expression of the SSR2 gene in this desmosterol accumulating strain resulted in the production of cholesterol.
An ergosterol deficient strain of S. cerevisiae can for example be made by deleting the genes erg4 and erg 5 in S. cerevisiae (eg. BG4742 erg4 erg5, Sawai et al. 2014). The same can be done in Yarrowia lipolytica by deleting the orthologues of erg4 and erg 5. Such ergosterol deficient strain can be made to express isofucosterol as a primary sterol by expressing the SMT2 cDNA or any enzyme with the same activity in this strain (Strain T55 see fig).
An ergosterol deficient strain of S. cerevisiae can for example be made by deleting the genes erg4 and erg 5 or erg5 alone in S. cerevisiae (eg. BG4742 erg4 erg5, Sawai et al. 2014). The same can be done in Yarrowia lipolytica by deleting the orthologues of erg4 and erg 5). Such ergosterol deficient strain can be made to express campesterol as it primary (>90%) sterol by expressing the DWF1 cDNA or DHCR7 gene any enzyme with the same activity in this strain (Strain T55).

A yeast producing cholesterol as its principle sterol (>90%) can also be made by deleting the erg 5 and erg 6 genes of the yeast and expressing the DHCR24 and DCHR7 enzymes (see strain RH6829).

TABLE 2
Yeast engineered to express specific sterols found in bee tissues

| | | Genes | Genes | |
|---|---|---|---|---|
| Sterol | Yeast sp. | inserted | deleted | Reference |
| 24MC | S. cerevesiae | St DWF5 | Δerg4, | Sawai et al. 2014 Plant Cell |
| | | | Δerg5 | 26(9): 3763-3774 |
| b-SIT | S. cerevesiae | AtDWF7, | Δerg4, | Xu et al. 2020 ACS Synth. Biol. |
| | | AtDWF5, | Aare1, | 2020, 9, 11, 3157-3170 |
| | | AtDWF1, | Aare2 | |
| | | AtSMT2 | | |
| CMP | S. cerevesiae | AtDWF7 | Δerg5 | Xu et al. 2020 ACS Synth. Biol. |
| | | | | 2020, 9, 11, 3157-3170 |
| CMP | Y. lipolytica | XIDHCR7 | Δerg5 | Du etal 2016 PLOS One |
| | | | | 11(1): e0146773 |
| CMP | Y. lipolytica | XIDHCR7 x2 | Δerg5 | Qian et al. 2020 Applied |
| | | | | Microbiology and |
| | | | | Biotechnology 104:7165-7175 |
| CMP | Y. lipolytica | DHCR7 | ACL and | Zhang et al. Biotech Letters |
| | | | POX2 | 39: 1033-1039 |
| CHO | S. cerevesiae | DrDHCR7, | Δerg5, | Souza et al. 2011 Metab Eng |
| | | DrDHCR24 | Δerg6 | 13(5): 555-569; |
| CHO | P. pastoris | DrDHCR7, | Δerg5, | Hirz et al. 2013 Appl Microbiol |
| | | DrDHCR24 | Δerg6 | Biot. 97(21): 9465-9478 |
| CHO | S. cerevesiae | StDWF5, | Δerg6 | Sawai et al. 2014 Plant Cell |
| | | StSSR2 | | 26(9): 3763-3774 |
| CHO | S. cerevesiae | StDWF5, | Δerg4, | Sawai et al. 2014 Plant Cell |
| | | StSSR2 | Δerg5 | 26(9): 3763-3774 |
| CHO | Y. lipolytica | SSR2, | Δerg5 | Xu et al. 2020 ACS Synth. Biol. |
| | | StDWF5 | | 2020, 9, 11, 3157-3170 |
| DES | Y. lipolytica | StDWF5 | Δerg5 | Xu et al. 2020 ACS Synth. Biol. |
| | | | | 2020, 9, 11, 3157-3170 |
| DES | S. cervesiae | DHCR24 | — | Ciufo et al. 2011 PLOS One |
| | | | | 6(6): e21316. |
| DES | S. cervesiae | St DWF5 | Δerg6 | Sawai et al. 2014 Plant Cell |
| | | | | 26(9):3763-3774 |
| ISOF | S. cervesiae | SMT2, | Δerg5 | Xu et al. 2020 ACS Synth. Biol. |
| | | AtDWF7 | | 2020, 9, 11, 3157-3170 |

S. cervesiae = Saccharomyces cervesiae,
Y. lipolytica = Yarrowia lypolytica,
P. pastoris = Piscia pastoris

Various methods exist to increase the expression level of metabolites in yeast strains to significantly higher levels are well known to people skilled in the art. Examples include:
Using Y. lipolytica as yeast species versus S. cerevisiae,
Addition of copies or overexpression of specific enzymes in the pathway such as the DWF7 gene I dwf5/dwf1 expressing strain,
Replacing regulatory elements in genes in the pathway to remove sources or bottlenecks in the pathway,
Replacing genes the pathway by orthologous genes of other organisms,
Addition of copies or overexpression of an general inducing factor of the steroid pathway,
Selecting the strain under heat or selecting strains that are more resistant to ionic liquid stress,
Changing the substrate on which the yeast is grown,
Rounds of mutation and selection to identify high producing strains,
Modification of the expression levels in the sterol ester and sterol-acetate pathway, leading to removal of negative feedback inhibition on cholesterol producing enzymes.

### Invertebrate Antinutrients

Therefore a manufacturer of bee food has very few commercially available and cost-acceptable sources of the specific phytosterols relevant to bees that can be incorporated into a formula in the right composition, quantity, and ratios relevant for bees. Current feeds are, therefore, by definition nutritionally incomplete because they are missing essential sterols.

Yeasts such as Saccharomyces cerevisiae and Yarrowia lypolitica are some of the most important micro-organisms used for the commercial production of fats and other fat derived compounds such as sterols and steroids. Many marine algae and diatoms contain a diverse array of sterols are also being engineered to produce lipid compounds (Rampan et al 2010, Gallo et al. 2020). Furthermore, several plant species have been engineered to produce or express specific sterols or lipid compounds (Sawai et al. 2014). Invertebrates have not been widely manipulated for lipid or sterol content, but have the potential to be in the future as information about their genomes and metabolic pathways are revealed. Most of these sources contain very low levels of sterols and as a whole could not be incorporated in bee food without concentrating or extracting the sterols which is cost-prohibitive.

Some fungi including S. cerevisiae, Torula can be incorporated in bee food as a source of proteins, vitamins, amino acids. The yeast used today in the food and feed industry have products fully based on yeast. However, these particular yeasts contain antinutrients for bees.

Furthermore in a commercial bee food, all the nutritional elements required (proteins, fats, micro-nutrients, minerals) need to be incorporated from commercially acceptable and available sources. The available feed sources only have trace amounts of some of the phytosterols bees need (Table 1) and when these sterols are present, they are not present in the ratios appropriate for bees. One, therefore, cannot use the currently available feed sources to reach the desired levels and composition without compromising the concentration of other nutrients.

Furthermore there is no commercially available cost effective source of isofucosterol, 24-methylene cholesterol, cholestanol, desmosterol or other sterols or stanols required by invertebrates. The only commercially available source of cholesterol as animal feed additive that is unadulterated with antinutrients is from an extract of animal origin (sheep wool or poultry products).

A solution to the above problem is to use a microorganism or algae or another invertebrate or a combination of such organisms that naturally or after metabolic engineering, mutation, selection do not contain the anti-nutrient ergosterol or other anti-nutrients.

Another embodiment is to incorporate in the invertebrate feed a yeast or other microorganism that instead of ergosterol produces the desired sterols through metabolic engineering, mutation or selection.

Thirdly, one could also use an extract of such an organism containing the sterols.

### Non-Pollen Composition

The composition of the invention is advantageously a non-pollen composition.

The feature “non-pollen” means essentially free of pollen. However, minor amounts of pollen may be present in the compositions of the present inventions. In one embodiment, the amount of pollen is 15 w % or less, preferably 10 w % or less, even more preferably 5 w % or less and even more preferably 1 w % or less and even more preferably 0.1 w % or less as compared to the dry weight of the composition.

In another embodiment, the composition is a pollen substitute composition that replaces a pollen diet.

### Invertebrates

Invertebrate species are the most diverse animals on earth. They are important components of natural ecological systems and play key roles in the production of human food. An increasingly important area of food production involves the cultivation of invertebrates such as insects, crustaceans, and molluscs as food for humans and for livestock and for their roles in ecosystem services such as pollination. Insects are also cultivated as natural enemies of insect pests and released as part of integrated pest management strategies.

Invertebrates include
arthropods, such as insects, arachnids, crustaceans, and myriapods,
molluscs, such as chitons, snail, bivalves, squids, and octopuses,
annelid, such as earthworms and leeches; and
cnidarians, such as hydras, jellyfishes, sea anemones, and corals.

Preferred invertebrates are invertebrates that are cultured or farmed for purposes of human or animal nutrition such as bees, bumble bees, earthworms, meal worms, shrimps, prawns or crayfish, crickets and fly larvae. Particularly preferred invertebrates are those of the Apidae family which are used as pollinators for agricultural or horticultural plants, such as
bees of the genus Apis and in particular Apis mellifera or
bumble bees of the genus Bombus and in particular Bombus terrestris

### Dosage and Concentration

The invertebrate nutrient, in particular the cholesterol, desmosterol, 24-methylene cholesterol, 24-methylenecholst-7-enol, cholestanol, 7-dehydrocholesterol, campesterol, stigmasterol, b-sitosterol, isofucosterol or fucosterol is administered in an amount that is nutritionally effective for invertebrates.

In one embodiment, nutritionally effective means a concentration of invertebrate nutrient, in particular the cholesterol, desmosterol, 24-methylene cholesterol, 24-methylenecholst-7-enol, cholestanol, 7-dehydrocholesterol, campesterol, stigmasterol, b-sitosterol, isofucosterol or fucosterol or fucosterol or mixtures thereof in an amount from 0.01 w % to 5 w %, preferably from 0.02 w % to 2 w %, and even more preferably from 0.03 w % to 0.6 w % of the dry weight of the pollen substitute composition.

In one embodiment, the dosage of isofucosterol that a beekeeper would use for a colony of honey bees should be approximately 0.1-0.5% of the total weight of the diet. If each nurse bee weighs 120 mg and consumes 10-15 mg of food per day, and if a colony of bees is made up of approximately 50% nurse or young adult worker bees, this would be between 5-25 mg of isofucosterol per colony per day.

In one embodiment, for a bumblebee colony composed of 300 bees, the diet should include isofucosterol in quantities of 0.3-0.8% of the total weight of the diet. If each bumblebee weighs approximately 200 mg and consumes 20 mg of food per day, and if all bees consume the food, then the effective dose of isofucosterol would be 2-5 mg per day per colony.

### Examples

### Comparative Example 1: Sterol Nutrient and Antinutrient Levels in Commercial Bee Feed

Commercially available non-pollen bee feed compositions do not comprise essential nutrients and do comprise antinutrients as shown in comparative Table 1 below.

### Comparative Table 1:

TABLE 1
Sterol composition (% total of relevant sterols)
of bees and commercial pollen substitutes

| | | | | | | | | Total |
|---|---|---|---|---|---|---|---|---|
| | CHO | DES | 24-M | CAMPE | STIGM | B-SITO | ISOFUC | (μg/g) |
| Honey bees | | | | | | | | |
| Bee-collected | 1.0 | 0.2 | 49.0 | 4.6 | 0.9 | 13.1 | 31.1 | 1587.9 |
| mixed pollen | | | | | | | | |
| Bee bread | 1.3 | 0.7 | 39.7 | 5.1 | 0.9 | 21.1 | 31.3 | 1338.6 |
| Royal jelly | 1.9 | 2.0 | 62.8 | 5.5 | 0.6 | 17.5 | 9.9 | 837.9 |
| Queen | 1.1 | 0.4 | 29.0 | 15.2 | 11.2 | 34.8 | 8.4 | 5429.2 |
| Drone | 1.7 | 0.2 | 45.6 | 7.6 | 3.0 | 24.3 | 17.5 | 2840.1 |
| Worker | 1.8 | 0.9 | 45.0 | 6.2 | 0.7 | 26.4 | 19.0 | 1794.6 |
| Bumble bees | | | | | | | | |
| Larva | 0.6 | 0.8 | 17.2 | 4.0 | 0.6 | 21.2 | 55.8 | 1674.5 |
| Queen | 1.4 | 0.2 | 23.4 | 8.3 | 1.7 | 14.1 | 51.1 | 429.8 |
| Drone | 0.3 | 0.3 | 28.1 | 6.1 | 0.6 | 23.6 | 41.1 | 1469.7 |
| Worker | 0.5 | 0.2 | 17.8 | 6.1 | 0.9 | 24.7 | 49.8 | 2116.9 |
| Svoboda et al. 1980 | | | | | | | | |
| Worker | 1.2 | 1.1 | 46.6 | 8.8 | 3.9 | 23 | 15.4 | N/A |
| Commercial bee feeds | | | | | | | | |
| UltraBee | 0.0 | 0.0 | 1.4 | 19.9 | 6.5 | 62.6 | 0.0 | 2147.3 |
| MegaBee | 0.0 | 0.0 | 1.7 | 19.6 | 6.5 | 68.1 | 0.0 | 1489.8 |
| AP23 | 7.1 | 0.0 | 0.5 | 16.1 | 5.8 | 58.3 | 0.0 | 1458.3 |
| BeePro | 0.0 | 0.0 | 0.3 | 15.2 | 7.6 | 39.2 | 0.0 | 509.2 |
| Broodbuilder | 0.0 | 0.0 | 0.1 | 12.6 | 5.5 | 28.7 | 0.0 | 280.4 |
| FeedBee | 3.8 | 0.0 | 0.7 | 14.8 | 5.7 | 69.0 | 0.0 | 879.8 |

* from Svoboda et al 1980 JInsPhys 26: 291-294
** methods for analysis from Zu et al. 2021 New Phyt 230: 1169-1184
CHO = cholesterol,
DES = desmosterol,
24M = 24-methylene cholesterol,
CAMPE = campesterol,
STIGM = stigmasterol,
b-SITO = b-sitosterol,
ISOFUCO = isofucosterol

### Example 1-Preference Essay: Bees Prefer Specific Concentrations of Isofucosterol in Foods

Newly emerged adult worker honey bees (Apis mellifera) or adult worker bumble bees (Bombus terrestris) were tested in a two-choice preference assay in which bees had access to two diets and ad libitum access to water.

One treatment diet contained the isofucosterol and the other contained no sterol. Newly emerged bees were removed from the brood frame and cohorts of 30 bees per replicate were housed in plastic rearing cages. In all experiments, 10 cohorts of ˜30 bees each were used for each treatment group. In all diets carbohydrate was maintained at 60% using powdered sugar and fat was maintained at 8% using an emulsion. Maltodextrin was used as a variable filler. Consumption of each diet was measured every 24 h for 5 days. Preference index was calculated as (amount of treatment consumed-amount of control consumed)/(total amount of food consumed).

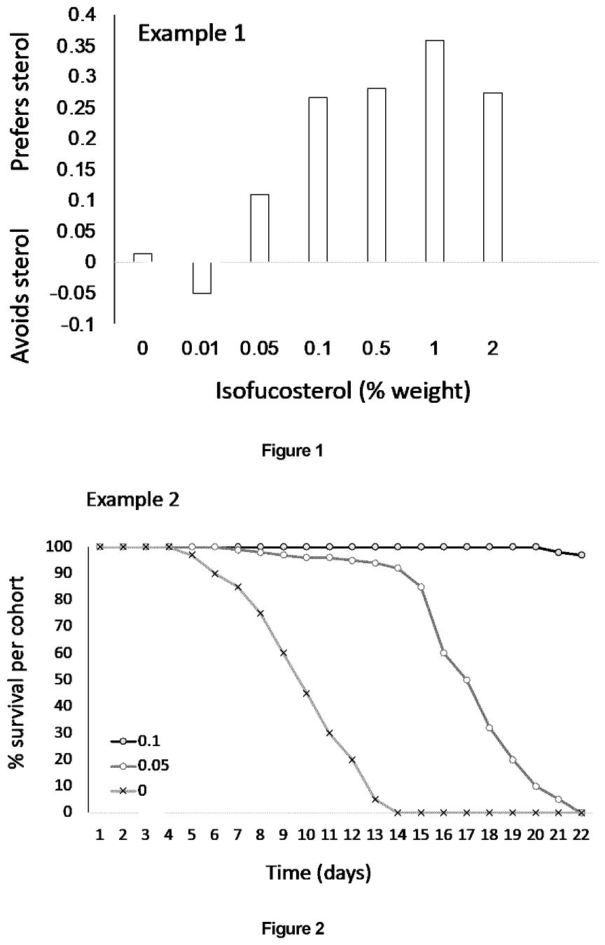

In Example 1, cohorts of bees were given a choice of diet with or without isofucosterol. Bees preferred to consume food that contained at least 0.05% isofucosterol in the diet, as shown in FIG. 1.

### Example 2-Survival: Bees Live Longer on Foods Containing Isofucosterol

Newly emerged adult worker honey bees fed with a diet treatment and ad libitum access to water. The treatment diet contained the isofucosterol. Newly emerged bees were removed from the brood frame and cohorts of 30 bees per replicate were housed in plastic rearing cages. In all experiments, 10 cohorts of ˜30 bees each were used for each treatment group. In all diet's carbohydrate was maintained at 60% using powdered sugar and fat was maintained at 8% using an emulsion. Maltodextrin was used as a variable filler. Consumption of each diet was measured every day over the course of the experiment. The number of bees alive in the box was counted each day for 14 days.

Example 2 represents the survival of cohorts of bees confined to feed on diets containing specific concentrations of isofucosterol (0%, 0.5% and 1% weight of diet), as shown in FIG. 2.

### Example 3-Brood Production: Honey Bees Produce More Brood with Isofucosterol and Produce Brood for Longer Periods of Time

Honey bees: Fully functional insulated styrofoam APIDEA nucs comprised 5 mini frames populated with adult workers and 1 mated laying queen bee were populated with 300-400 ml of young adult workers (˜ N<1,000 bees of mixed ages).

The colony was located in an enclosed glasshouse with ventilation which did not permit the honey bees to forage on nectar or pollen. Each treatment was tested with 3-6 colonies; each colony was fed with a 60-100 g patty (solid diet) on the top feeder fitted with a mesh floor. Diet was fed on the first day and again on day 6; the quantity consumed was measured on day 6 and day 15. If no larvae or eggs are observed by day 6 then the experiment is terminated. The number of capped brood cells was counted on day 15. The number of bee seams was estimated during each inspection. Sugar syrup (34%) and water was provided in feeders inside the tent to prevent carbohydrate starvation and to stimulate foraging activity.

In Example 3, bees were fed with a diet containing 10-18% protein, 6% fat, 1% vitamins/minerals and >75% carbohydrates.

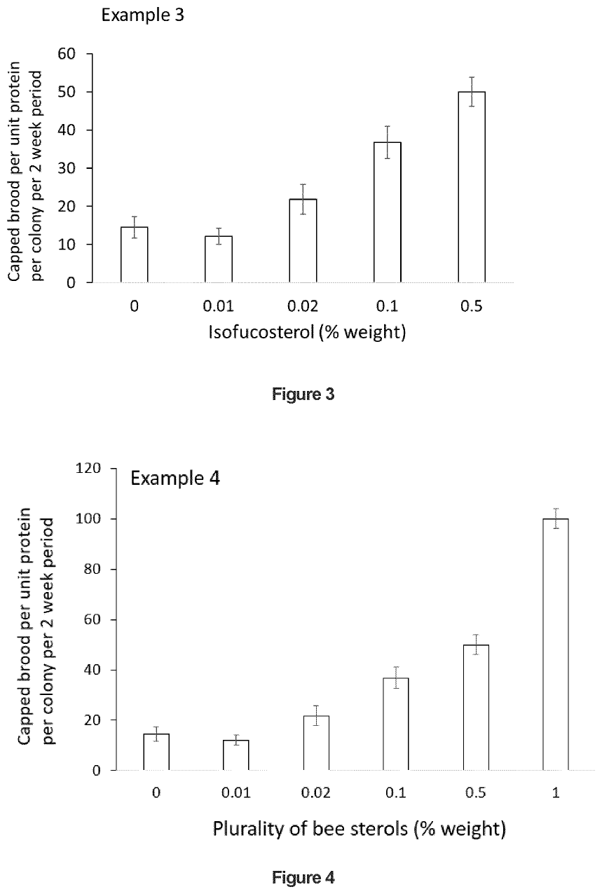

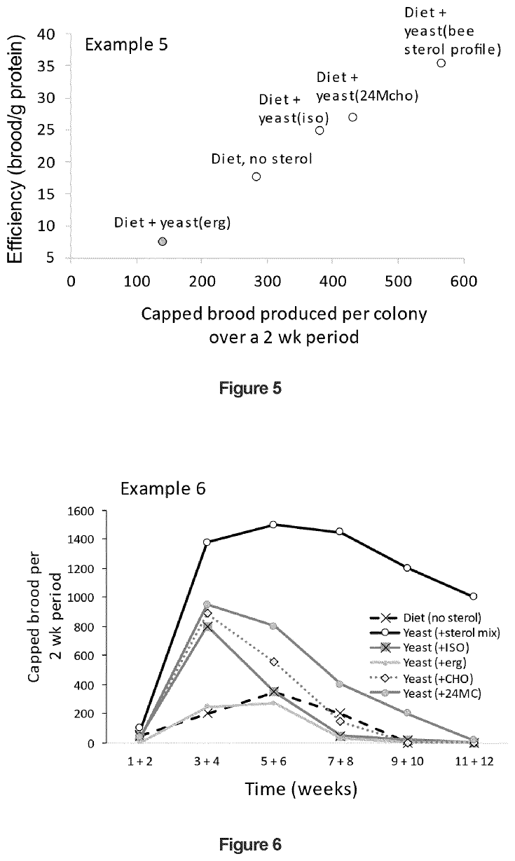

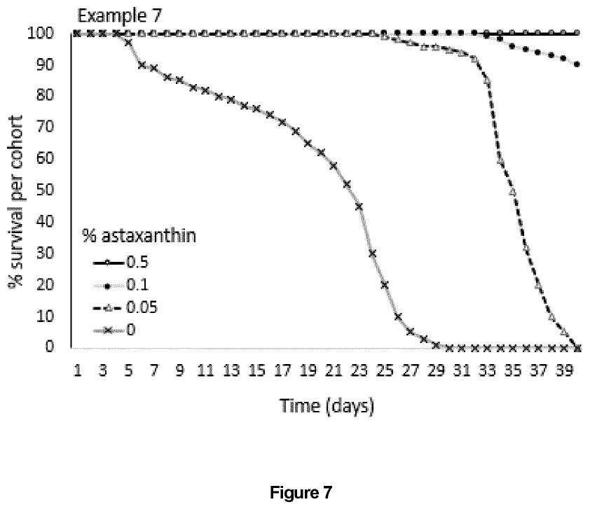

FIG. 3 exhibits the threshold of example 3 for the influence of isofucosterol in bee diet. As the concentration of isofucosterol increased, the amount of brood produced in each colony increased (N>3 colonies/treatment). The pupae, and the number of new adults was counted over the entire 10-week period.

Example 4-Brood production: Honey bees produce more brood with a plurality of sterols and produce brood for longer periods of time.

Example 5-Honey bees were more efficient at producing brood per unit protein when sterols were added to diet.

Example 6-Honey bees produced brood for longer period with a plurality of required sterols than with any other sterol provision.

Example 7-Survival: bees live longer on foods containing astaxanthin.

1. A method for feeding invertebrates comprising:
providing a composition comprising a microbial organism or parts, extracts, oils, mixtures or refinements thereof; and
administering the composition to invertebrates,
wherein the microbial organism is selected from the group consisting of Saccharomyces cerevisiae, Xanthophyllomyces sp., Schizosaccharomyces japonicus or Yarrowia lipolytica; and
wherein the microbial organism has been genetically modified or selected to produce an invertebrate nutrient selected from the group consisting of cholesterol, desmosterol, 24-methylene cholesterol, and isofucosterol.

2. The method of claim 1, wherein the yeast has been modified or enhanced as compared to a parent microorganism to express a squalene-hopene cyclase enzyme or a squalene-tetrahymenol cyclase enzyme to enable growth under anoxic conditions.

3. The method of claim 1, wherein the invertebrate nutrient is produced under aerobic conditions.

4. The method of claim 1, wherein the microorganism has been further selected or modified not to express or produce invertebrate antinutrients.

5. The method of claim 1, wherein the invertebrate antinutrient is a sterol such as zymosterol or ergosterol.

6. The method of claim 1, wherein the composition is a whole invertebrate diet, part of an invertebrate diet or a dietary supplement.

7. The method of claim 1, wherein the composition is administered to invertebrates of the Apidae family, in particular honey bees or bumble bees.

8. The method of claim 1, wherein the composition is administered
a. in solid form such as a patty or in liquid form such as a solution or spray;
b. inside or outside the hive.

9. The method of claim 1, wherein there is a chemical, chromatographic or enzymatical modification step to obtain the invertebrate nutrient.

10. The method of claim 1, wherein the composition comprises:
proteins in an amount from 10 w % to 50 w %, preferably of 20 w % to 40 w %,
fatty acids in an amount from 1 w % to 20 w %, preferably of 2 w % to 12 w %,
carbohydrates in an amount from 30 w % to 90 w %, preferably of 50 w % to 70 w %,
optionally vitamins, and
optionally minerals,
wherein the total amount of components add up to 100 w % and wherein the w % are related to the total dry weight of the composition.

11. The method of claim 1, wherein the composition comprises an insect nutrient selected from then group consisting of cholesterol, desmosterol, 24-methylene cholesterol, and isofucosterol in an amount:
From 0.01-5% of the diet as individual compounds, where no compound is ever less than 0.01% of the diet and from 0.1-5% of the diet in a mixture; or
As a mixture, preferably from 0.1-1% and even more preferably from 0.3-0.5% for honey bees and 0.3-0.8% for bumble bees as a percentage of the total weight of the pollen substitute composition; and/or.

12. The method of claim 1, wherein the composition further comprises an insect nutrient including polyphenols in the following groups phenolic acids, proanthocyanidins, epicatechins, catechins, and flavonoids such as quercetin, naringenin, p-coumaric acid or mixtures thereof in an amount from 0.01-5% of the diet, preferably from 0.01-1% and even more preferably from 0.03-0.5% for honey bees and 0.03-0.8% for bumble bees as a percentage of the total weight of the pollen substitute composition and where the predominant class of phenolics is either proanthocyanidins or flavonoids and makes up at least 30% of the total polyphenols and preferably is 70-100% of the total polyphenols.

13. The method of claim 1, wherein the composition further comprises of an insect nutrient selected from the group consisting of carotenoids or xanthophylls such as b-carotene, lycopene, or astaxanthin or mixtures thereof in an amount from 0.01-5% of the diet, preferably from 0.01-1% and even more preferably from 0.03-0.5% for honey bees and 0.03-0.8% for bumble bees as a percentage of the total weight of the pollen substitute composition.

14. The method of claim 1, wherein the composition is essentially free of pollen.

15. Use of the composition of claim 1 for feeding invertebrates, in particular honey bees or bumble bees or stingless bees.
